(19) United States
(12) Patent Application Publication
(10) Pub. No.: US 2025/0149800 A1
(43) Pub. Date: May 8, 2025

(54) REFLECTING DEVICE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP)

(73) Assignee: Japan Display Inc., Tokyo (JP)

(21) Appl. No.: 19/002,759

(22) Filed: Dec. 27, 2024

Related U.S. Application Data
(63) Continuation of application No. PCT/JP2023/021593, filed on Jun. 9, 2023.

(30) Foreign Application Priority Data
Jun. 30, 2022 (JP) 2022-106685

(51) Int. Cl. H01Q 15/14; G02F 1/1343

(52) U.S. Cl. CPC H01Q 15/147; G02F 1/13439

(57) ABSTRACT

A reflecting device includes a plurality of first patch electrodes, a plurality of second patch electrodes having a size different from a size of the first patch electrodes, a ground electrode opposing the plurality of first patch electrodes and the plurality of second patch electrodes and separated from the plurality of first patch electrodes and the plurality of second patch electrodes, and a liquid crystal layer between the plurality of first patch electrodes and the plurality of second patch electrodes and the ground electrode, wherein the plurality of first patch electrodes and the plurality of second patch electrodes are arranged alternately in a first direction or a second direction intersecting the first direction, and each first patch electrode is adjacent to each second patch electrode in the first direction or the second direction.

### CROSS-REFERENCE TO RELATED APPLICATIONS

This application is a Continuation of International Patent Application No. PCT/JP2023/021593, filed on Jun. 9, 2023, which claims the benefit of priority to Japanese Patent Application No. 2022-106685, filed on Jun. 30, 2022, the entire contents of each are incorporated herein by reference.

### FIELD

An embodiment of the present invention relates to a reflecting device that can control the direction of travel of reflected radio waves.

### BACKGROUND

A phased array antenna device controls the directionality of the antenna while it is fixed in place by adjusting the amplitude and phase of the high-frequency signal applied to each of the plurality of antenna elements arranged in a plane. Phased array antenna devices require phase shifters. A phased array antenna device that uses a phase shifter that makes use of the change in a dielectric constant due to the orientation of the liquid crystal has been disclosed (see, for example, Japanese laid-open patent publication No. H11-103201).

The antenna elements of the phased array antenna device in Japanese laid-open patent publication No. H11-103201 have a plurality of strip wirings, a planar electrode facing the plurality of strip wirings, and a liquid crystal layer between the plurality of strip wirings and the planar electrode. In the plurality of antenna elements, different voltages are applied to the plurality of strip wirings. The phase of the reflected wave can then be changed by adjusting the dielectric constant of the liquid crystal layer for each antenna element. This allows the direction of the reflected wave to be set to any desired direction.

### SUMMARY

A reflecting device according to an embodiment of the present invention includes a plurality of first patch electrodes, a plurality of second patch electrodes having a size different from a size of the first patch electrodes, a ground electrode opposing the plurality of first patch electrodes and the plurality of second patch electrodes and separated from the plurality of first patch electrodes and the plurality of second patch electrodes, and a liquid crystal layer between the plurality of first patch electrodes and the plurality of second patch electrodes and the ground electrode, wherein the plurality of first patch electrodes and the plurality of second patch electrodes are arranged alternately in a first direction or a second direction intersecting the first direction, and each first patch electrode is adjacent to each second patch electrode in the first direction or the second direction.

### BRIEF DESCRIPTION OF DRAWINGS

FIG. 1A is a plan view of a reflector unit cell used in a reflecting device according to an embodiment of the present invention.

FIG. 1B is a cross-sectional view between A1 and A2 in a plan view shown in FIG. 1A.

FIG. 2A is a diagram showing a state in which no voltage is applied between a patch electrode and a ground electrode in a reflector unit cell used in a reflecting device according to an embodiment of the present invention.

FIG. 2B is a diagram showing a state in which a voltage is applied between a patch electrode and a ground electrode in a reflector unit cell used in a reflecting device according to an embodiment of the present invention.

FIG. 3 is a schematic diagram showing how a direction of reflected waves changes according to an embodiment of the present invention.

FIG. 4 is a diagram showing the results of a simulation of a relationship between frequency and amplitude when two different sizes of patch electrode are used in a reflecting device according to an embodiment of the present invention.

FIG. 5 is a diagram showing the results of a simulation of a relationship between frequency and phase when two different sizes of patch electrode are used in a reflecting device according to an embodiment of the present invention.

FIG. 6 is a diagram showing a configuration of a reflecting device according to an embodiment of the present invention.

FIG. 7 is a diagram showing a configuration of a reflecting device according to an embodiment of the present invention.

FIG. 8 is a cross-sectional configuration of a reflector unit cell in a reflecting device according to an embodiment of the present invention.

FIG. 9 is a diagram showing a configuration of a reflecting device according to a First Modification.

FIG. 10 is a diagram showing a configuration of a reflecting device according to a Second Modification.

FIG. 11 is a diagram showing the results of a simulation of a relationship between frequency and amplitude when a single size of patch electrode is used in a reflecting device according to an embodiment of the present invention.

FIG. 12 is a diagram showing the results of a simulation of a relationship between frequency and phase when a single size of patch electrode is used in a reflecting device according to an embodiment of the present invention.

FIG. 13 is a diagram showing the results of a simulation of a relationship between frequency and amplitude when patch electrodes having two significantly different sizes are used in a reflecting device according to an embodiment of the present invention.

FIG. 14 is a diagram showing the results of a simulation of a relationship between frequency and phase when patch electrodes having two significantly different sizes are used in a reflecting device according to an embodiment of the present invention.

### DESCRIPTION OF EMBODIMENTS

The following is an explanation of the embodiment of the present invention with reference to the drawings and other materials. However, the present invention can be implemented in many different ways, and the content of the description of the embodiment given below is not to be interpreted as being limited to the content of the description of the embodiment given below. In order to make the explanation clearer, the drawings may show the width, thickness, shape, etc. of each part in a schematic manner compared to the actual shape, but this is just an example and does not limit the interpretation of this invention. In this specification and in the figures, the same symbols (or symbols with a, b, etc. added after numbers) are used for the same elements as those described previously with respect to previously-described figures, and detailed explanations may be omitted as appropriate. Furthermore, the terms “1st” and “2nd” added to each element are convenient signs used to distinguish the elements, and unless otherwise specified, they have no further significance.

In the present disclosure, when a component or region is said to be “above (or below)” another component or region, this includes not only the case where it is directly above (or below) another component or region, but also the case where it is above (or below) another component or region, that is, where another component is included in between above (or below) another component or region.

### First Embodiment

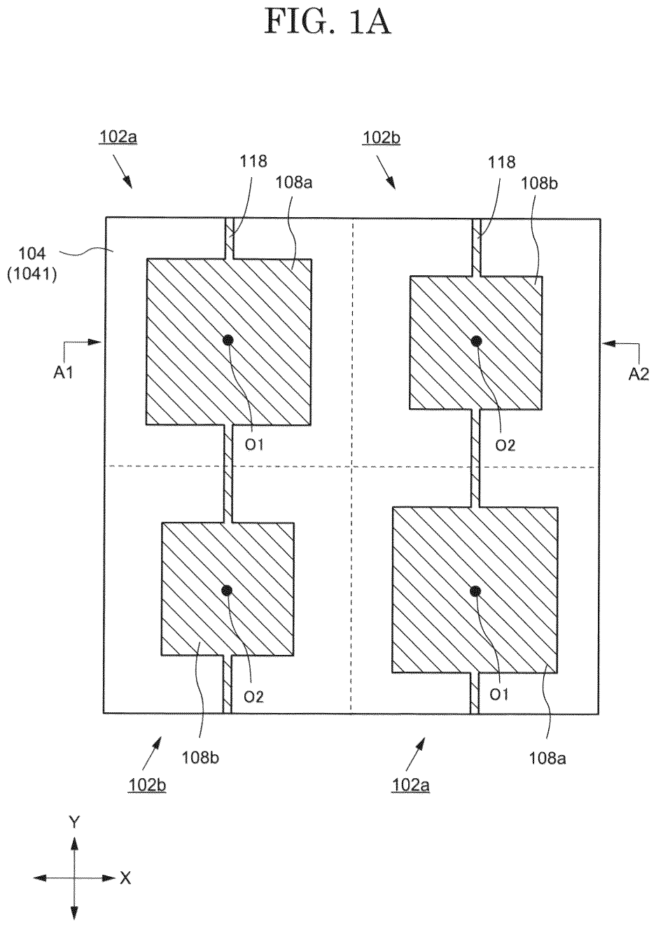

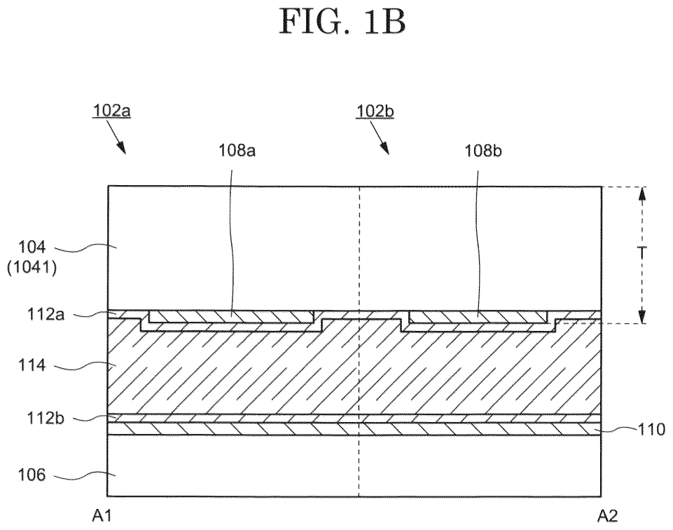

In this embodiment, a reflecting device according to an embodiment of the present invention is explained with reference to FIG. 1A to FIG. 10.

### 1. Reflector Unit Cell

First, reflector unit cells 102a and 102b used in the reflecting device will be explained.

FIG. 1A is a plan view of the reflector unit cells 102a and 102b used in the reflecting device according to an embodiment of the present invention as seen from above (the side where the radio waves enter). FIG. 1B is a cross-sectional view between A1 and A2 as shown in FIG. 1A.

As shown in FIG. 1A and FIG. 1B, a reflector unit cell 102a includes a dielectric substrate 104, a counter substrate 106, a patch electrode 108a, a ground electrode 110, a liquid crystal layer 114, a first alignment film 112a, and a second alignment film 112b. A reflector unit cell 102b also includes the dielectric substrate 104, the counter substrate 106, a patch electrode 108b, the ground electrode 110, the liquid crystal layer 114, the first alignment film 112a, and the second alignment film 112b. In the reflector unit cells 102a and 102b, the dielectric substrate 104 can be considered as a single layer of a dielectric material. Therefore, the dielectric substrate 104 is sometimes referred to as the dielectric layer. The patch electrodes 108a and 108b are provided on the dielectric substrate 104, and the ground electrode 110 is provided on the counter substrate 106. The first alignment film 112a is formed on the dielectric substrate 104 to cover the patch electrodes 108a and 108b. The second alignment film 112b is provided on the counter substrate 106 to cover the ground electrode 110. The patch electrode 108a and the ground electrode 110 are arranged opposite each other, and the liquid crystal layer 114 is provided between them. Similarly, the patch electrode 108b and the ground electrode 110 are arranged opposite each other, and the liquid crystal layer 114 is provided between them. The first alignment film 112a is interposed between the patch electrodes 108a and 108b and the liquid crystal layer 114. The second alignment film 112b is interposed between the ground electrode 110 and the liquid crystal layer 114.

In an embodiment of the present invention, the difference between the reflector unit cell 102a and the reflector unit cell 102b is a size (or area) of the patch electrodes 108a and 108b. In FIG. 1A, a size of the patch electrode 108a is described as being larger than a size of the patch electrode 108b. In the following explanations, when there is no need to distinguish between the reflector unit cell 102a and the reflector unit cell 102b, they are simply referred to as the reflector unit cells 102. When there is no need to distinguish between the patch electrode 108a and the patch electrode 108b, they are simply referred to as the patch electrodes 108.

In this embodiment, when the reflector unit cells 102a and 102b are viewed in a plan view, the plurality of patch electrodes 108a and the plurality of patch electrodes 108b are arranged in a staggered pattern. Specifically, the plurality of patch electrodes 108a and the plurality of patch electrodes 108b are arranged alternately in a first direction (the X-axis direction) or a second direction (the Y-axis direction) that intersects the first direction. In addition, each patch electrode 108a is adjacent to each patch electrode 108b in the first direction or the second direction. In the patch electrodes 108a and 108b arranged in the first direction, a center O1 of the patch electrode 108a and a center O2 of the patch electrode 108b are arranged so that they are aligned in the first direction. In the patch electrodes 108a and 108b, which are aligned in the second direction, the center O1 of the patch electrode 108a and the center O2 of the patch electrode 108b are aligned in the second direction.

A shape of the patch electrode 108 is preferably a shape that has rotational symmetry about a center O of the patch electrode 108. For example, the shape of the patch electrode 108 may be a shape that is rotationally symmetric four times, and have a square or diamond shape in a plan view. In addition, as a shape that is rotationally symmetric four times, it may be a square with chamfered corners, or a square with rounded corners. In addition, the shape of the patch electrode 108 may be circular. FIG. 1A shows a case where the patch electrode 108 is square in a plan view. The shape of the patch electrode 108 has rotational symmetry about the center of the patch electrode 108, which reduces the anisotropy of the reflection of radio waves with respect to vertical and horizontal polarizations of incident radio waves. In other words, it is possible to suppress a bias of the vertical and horizontal polarizations in the XY plane in FIG. 1A and reflect the vertical and horizontal polarizations uniformly. There are no particular restrictions on the shape of the ground electrode 110, which has a shape that spreads over almost the entire surface of the counter substrate 106 so that it has a larger area than the patch electrode 108.

Materials for forming the patch electrodes 108 and the ground electrodes 110 are not limited, and are formed using conductive metals or metal oxides. The dielectric substrate 104 may also have a first wiring 118. The first wiring 118 connects the patch electrodes 108a and 108b. The first wiring 118 can be used when applying a control signal to the patch electrodes 108a and 108b. The first wiring 118 can also be used when connecting the patch electrodes 108a and 108b, for example, when a plurality of reflector unit cells 102a and 102b are arranged.

The reflector unit cell 102 is used as a reflector 120 that reflects radio waves in a predetermined direction. Therefore, it is preferable that the reflector unit cell 102 does not attenuate the amplitude of the reflected radio waves as much as possible. As is clear from the structure shown in FIG. 1B, when radio waves propagating through the air are reflected by the reflector unit cell 102, the radio waves pass through the dielectric substrate 104 twice. The dielectric substrate 104 is preferably formed from a dielectric material such as glass or resin.

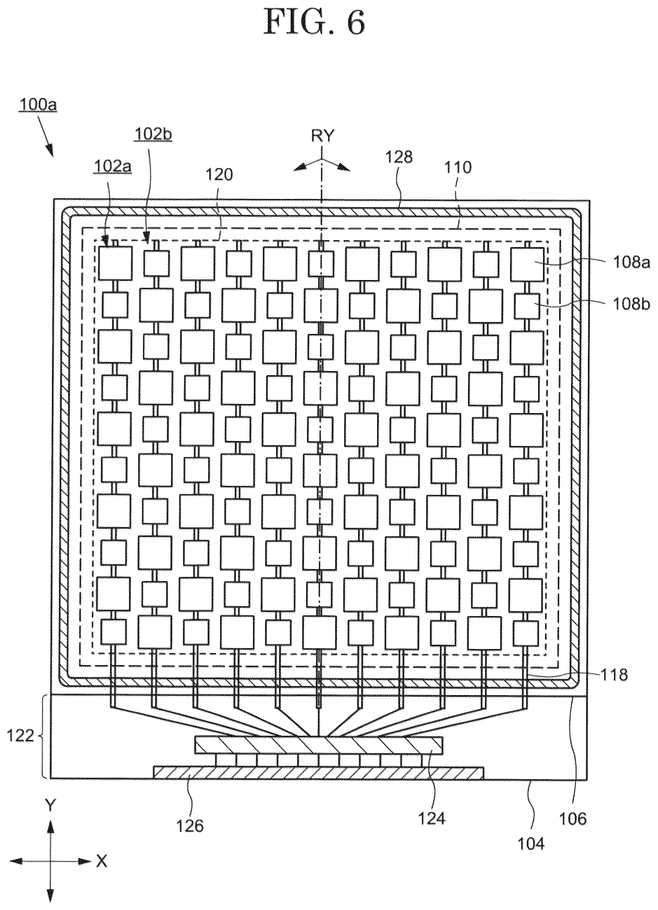

Although not shown in FIG. 1A and FIG. 1B, the dielectric substrate 104 and the counter substrate 106 are bonded together using a sealant 128 (see FIG. 6). The dielectric substrate 104 and the counter substrate 106 are arranged opposite each other with a gap between them. The liquid crystal layer 114 is provided to fill the region surrounded by the sealant 128. The gap between the dielectric substrate 104 and the counter substrate 106 is 20 μm to 100 μm, for example, 75 μm. A patch electrode 108, the ground electrode 110, the first alignment film 112a, and the second alignment film 112b are provided between the dielectric substrate 104 and the counter substrate 106. To be precise, the gap between the first alignment film 112a and the second alignment film 112b, which are provided on the dielectric substrate 104 and the counter substrate 106 respectively, is a thickness of the liquid crystal layer 114. Although not shown in FIG. 1B, a spacer may be provided between the dielectric substrate 104 and the counter substrate 106 to maintain a constant distance.

A control signal that controls an orientation of the liquid crystal molecules in the liquid crystal layer 114 is applied to the patch electrode 108. The control signal is either a direct current voltage signal or a polarity inversion signal in which positive and negative direct current voltages are alternately inverted. A voltage at an intermediate level between the ground or polarity inversion signal is applied to the ground electrode 110. The orientation of the liquid crystal molecules in the liquid crystal layer 114 changes when a control signal is applied to the patch electrode 108. A liquid crystal material with dielectric anisotropy is used for the liquid crystal layer 114. For example, nematic liquid crystal, smectic liquid crystal, cholesteric liquid crystal, and discotic liquid crystal are used as the liquid crystal layer 114. The liquid crystal layer 114, which has dielectric anisotropy, changes its dielectric constant according to changes in the orientation of the liquid crystal molecules. The reflector unit cell 102 can change the dielectric constant of the liquid crystal layer 114 by applying a control signal to the patch electrode 108. This allows the phase of the reflected wave to be delayed when reflecting radio waves.

The frequency bands of the radio waves reflected by the reflector unit cell 102 are the very high frequency (VHF) band, ultra high frequency (UHF) band, microwave (SHF) band, submillimeter wave (THF) band, and millimeter wave (EHF) band. The term “millimeter wave” refers to the frequency band between 30 GHz and 300 GHz. The fifth-generation communication standard, known as 5G, also includes the 26 GHz band to 29 GHz band, and the term “millimeter wave” is sometimes used to refer to frequencies above 26 GHz. The liquid crystal molecules in the liquid crystal layer 114 change their orientation in response to the control signal applied to the patch electrode 108, but they hardly follow the frequency of the radio waves incident on the patch electrode 108. Therefore, the reflector unit cell 102 can control the phase of the radio waves reflected without being affected by the radio waves.

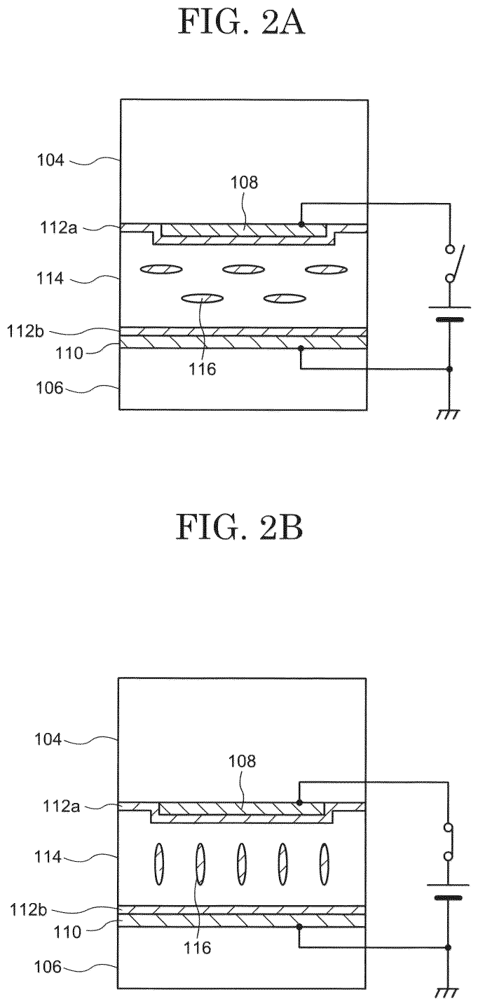

FIG. 2A shows a state in which no voltage is applied between the patch electrode 108 and the ground electrode 110 (this state shall be referred to as “First State”). FIG. 2A shows a case in which the first alignment film 112a and the second alignment film 112b are horizontal alignment films. In the first state, a long axis of the liquid crystal molecules 116 is oriented horizontally with respect to the surfaces of the patch electrode 108 and the ground electrode 110 by the first alignment film 112a and the second alignment film 112b. FIG. 2B shows the state in which a control signal (voltage signal) is applied to the patch electrode 108 (this state shall be referred to as “Second State”). In the second state, the long axis of the liquid crystal molecules 116 is oriented perpendicular to the surfaces of the patch electrode 108 and the ground electrode 110 due to the action of the electric field. An angle at which the long axis of the liquid crystal molecules 116 is oriented can be oriented in an intermediate direction between the horizontal and vertical directions, depending on the magnitude of the control signal applied to the patch electrode 108 (i.e., the magnitude of the voltage between the ground electrode and the patch electrode).

When the liquid crystal molecules 116 have positive dielectric anisotropy, a dielectric constant of the second state is larger than that of the first state. On the other hand, when the liquid crystal molecules 116 have negative dielectric anisotropy, the apparent dielectric constant of the second state is smaller than that of the first state. The liquid crystal layer 114 with dielectric anisotropy can be regarded as a variable dielectric layer. The reflector unit cell 102 can be controlled to delay (or not delay) the phase of the reflected wave by utilizing the dielectric anisotropy of the liquid crystal layer 114.

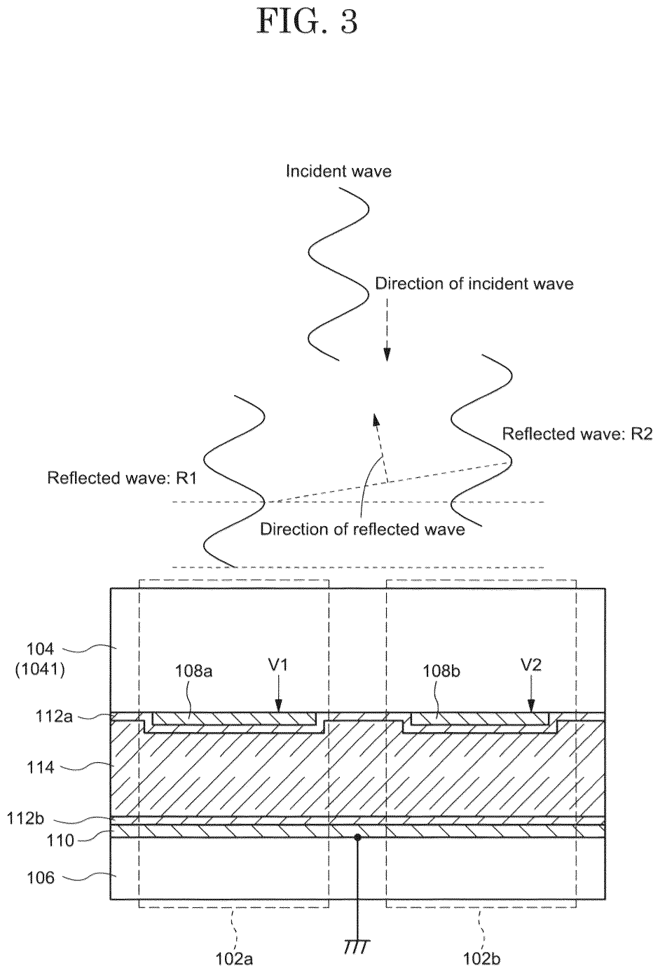

FIG. 3 shows schematically how a direction of the reflected wave is changed by the reflector unit cell 102a and reflector unit cell 102b. The reflector unit cell 102a and reflector unit cell 102b are adjacent in the first direction (X-axis direction). In other words, the patch electrode 108a and patch electrode 108b are connected to different first wiring 118. This shows the case where the phase change of the reflected wave by the reflector unit cell 102b is larger than that by the reflector unit cell 102a when radio waves with the same phase are incident on the reflector unit cells 102a and 102b, because different control signals (V1≠V2) are applied to the reflector unit cells 102a and 102b. As a result, the phase of the reflected wave R1 reflected by the reflector unit cell 102a differs from the phase of the reflected wave R2 reflected by the reflector unit cell 102b (in FIG. 3, the phase of the reflected wave R2 is advanced compared to the phase of the reflected wave R1), and the apparent direction of the reflected wave changes at an angle.

Next, the results of the simulation of the amount of phase change (deg) and amplitude (dB) in a reflecting device using two different sizes of patch electrodes are explained. In the simulation, as shown in FIG. 1A, the two types of patch electrodes are arranged in the first and second directions, and are assumed to be the reflecting plates of the reflecting device. The size of the patch electrode 108a is 2.8 mm×2.8 mm (7.84 mm²), and the size of the patch electrode 108b is 2.5 mm×2.5 mm (6.25 mm²). The pitch between patch electrode 108a and patch electrode 108b is 3.7 mm. In addition, a thickness of the liquid crystal layer 114 of the reflector unit cells 102a and 102b is 75 μm. The dielectric constant of the liquid crystal layer 114 was calculated for each dielectric constant, with ε=a, b, c (a>b>c). In addition, ε=a is the state in which voltage V1 is applied to the liquid crystal layer 114, and ε=c is the state in which no voltage is applied to the liquid crystal layer 114. In addition, ε=b is the state in which an intermediate voltage V2 is applied to the liquid crystal layer 114 (V1>V2>0).

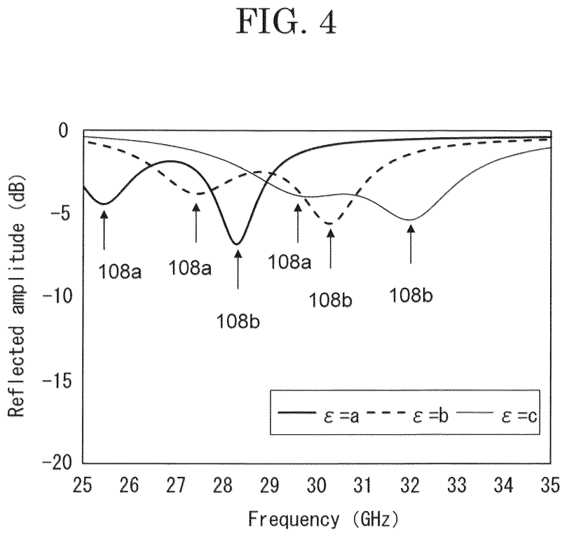

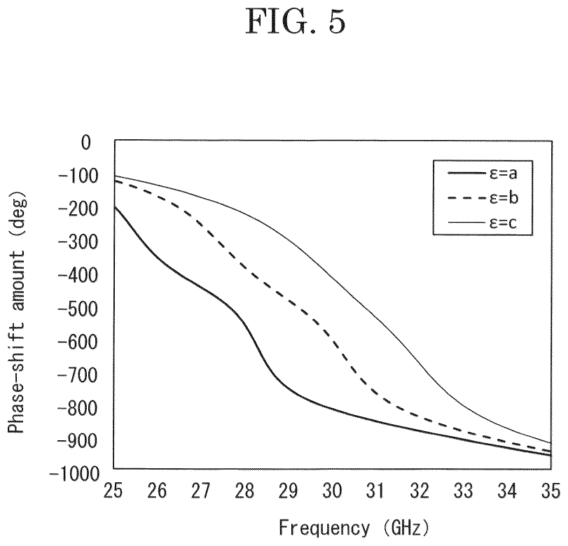

FIG. 4 shows a relationship between frequency and reflection amplitude in a reflecting device using two different sizes of patch electrode. FIG. 5 shows a relationship between frequency and phase change in a reflecting device using two different sizes of patch electrode. This simulation was performed using CST Studio Suite (Dassault Systèmes).

FIG. 4 shows that at 28 GHz, the reflection amplitude when ε=c (no voltage applied) is −1.8 dB, and the amplitude when ε=a (voltage applied) is −5.4 dB. According to FIG. 5, when the phase at 28 GHz is taken as the reference for ε=c, the phase change for ε=a is shown to be −335.2.

The size (area) of the patch electrode 108a used in the simulation is 25% larger than the size (area) of the patch electrode 108b. As a result, as shown in FIG. 5, it is indicated that there are two resonance frequency peaks (points where the reflection amplitude is minimum) for the dielectric constants ε=a, b, and c in the range of 25 GHz to 35 GHz. FIG. 5 shows the resonance frequency peaks caused by the patch electrode 108a and the resonance frequency peaks caused by the patch electrode 108b for each of the dielectric constants ε=a, b, and c.

Next, the results of simulations of the phase change (deg) and amplitude (dB) in a reflecting device using a single size of patch electrode are explained. In the simulation, a single size of patch electrode is arranged in the first and second directions, and is assumed to be a reflecting device reflector. The size of the patch electrode is 2.8 mm×2.8 mm (7.84 mm²). The pitch of the patch electrodes is 3.7 mm. In addition, a thickness of the liquid crystal layer 114 of the reflector unit cells 102a and 102b is 40 μm. The dielectric constant of the liquid crystal layer 114 was calculated for each dielectric constant, assuming ε=a, b, c (a>b>c). The dielectric constant ε=a is the state in which a voltage V1 is applied to the liquid crystal layer 114, and the dielectric constant ε=c is the state in which no voltage is applied to the liquid crystal layer 114. The dielectric constant ε=b is the state in which an intermediate voltage V2 is applied to the liquid crystal layer 114 (V1>V2>0).

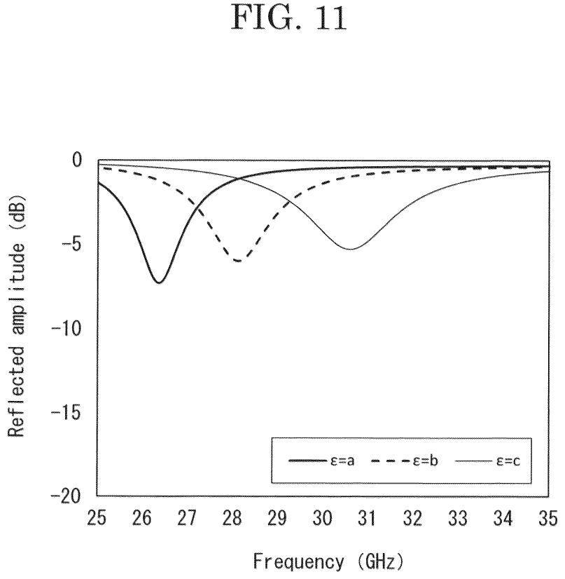

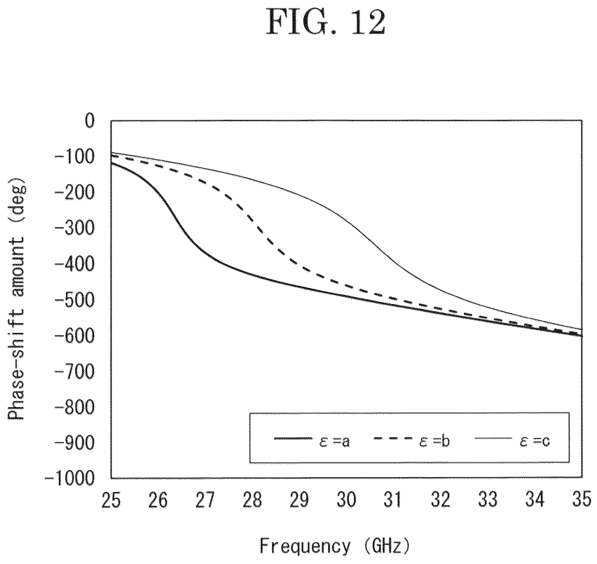

FIG. 11 shows the relationship between frequency and reflection amplitude in a reflecting device using a single type of patch electrode. FIG. 12 shows the relationship between frequency and phase change in a reflecting device using a single type of patch electrode. This simulation was performed using CST Studio Suite (Dassault Systèmes).

As shown in FIG. 11, the resonance frequency has one peak at any of the dielectric constants ε=a, b, or c. When using a single size of patch electrode (when all the patch electrode sizes are the same), insufficient reflection amplitude occurs due to material loss (dielectric tangent tan δ of the liquid crystal material and conductor loss of the patch electrode material) which causes insufficient reflection amplitude, and the range of variable dielectric constant is insufficient due to the limitation of the dielectric anisotropy of the liquid crystal material. As a result, as shown in FIG. 12, the phase change amount in the target frequency band is lower than the phase change amount required. Both of these are constrained by the material properties. Therefore, an embodiment of the present invention, which uses different sizes of patch electrodes in the reflecting device, is effective.

Next, the results of simulations of the amount of phase change (deg) and amplitude (dB) in a reflecting device using two different sizes of patch electrode are explained in the case where the size of patch electrode 108a is too large compared to the size of patch electrode 108b. In the simulation, one type of patch electrode is arranged in the first and second directions, and is assumed to be the reflecting device's reflector. The size of the patch electrode 108a is 3.1 mm×3.1 mm (9.61 mm²), and the size of the patch electrode 108b is 2.5 mm×2.5 mm (6.25 mm²). The pitch between the patch electrode 108a and the patch electrode 108b is 3.7 mm. In addition, the thickness of the liquid crystal layer 114 of the reflector unit cells 102a and 102b is 50 μm. The dielectric constant of the liquid crystal layer 114 was calculated for each dielectric constant, with ε=a, b, c (a>b>c). The dielectric constant ε=a is the state in which a voltage V1 is applied to the liquid crystal layer 114, and the dielectric constant ε=c is the state in which no voltage is applied to the liquid crystal layer 114. The dielectric constant ε=b is the state in which an intermediate voltage V2 is applied to the liquid crystal layer 114 (V2>V1>0).

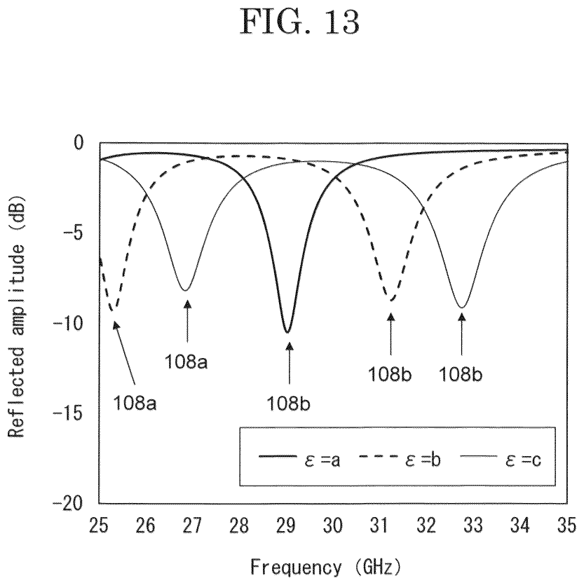

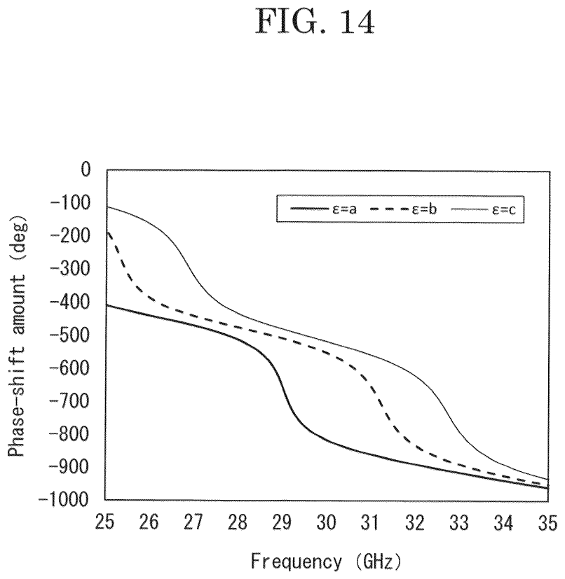

FIG. 13 shows the relationship between frequency and reflection amplitude in a reflecting device using two different sizes of patch electrode. FIG. 14 shows the relationship between frequency and phase change in a reflecting device using two different sizes of patch electrode. This simulation was performed using CST Studio Suite (Dassault Systèmes).

The size of the patch electrode 108a used in the simulation is 54% larger than the size of the patch electrode 108b. As a result, as shown in FIG. 13, the resonant frequency deviates greatly from the target frequency band (28 GHz band). Resonance occurs in two greatly deviated frequency bands. As a result, as shown in FIG. 14, the phase change amount in the target frequency band is lower than the phase change amount to be obtained, causing a problem.

The results of FIG. 4 and FIG. 5 suggest that the size of the patch electrode 108a should be 107% or more and 140% or less of the size of the patch electrode 108b. When the reflecting device 100a is used in the 28 GHz band, for example, the size of each patch electrode 108a is 7.0 mm² or more and 9.3 mm² or less, and the size of each patch electrode 108b is 5.5 mm² or more and 7.0 mm² or less.

In FIG. 1A, the plurality of patch electrodes 108a and the plurality of patch electrodes 108b are arranged so that they are adjacent to each other. In this case, it is preferable that the plurality of patch electrodes 108a and the plurality of patch electrodes 108b are arranged in a way that is two-fold rotationally symmetric or four-fold rotationally symmetric with respect to the center of the region where the plurality of patch electrodes 108a and the plurality of patch electrodes 108b are arranged in the first direction and the second direction. By arranging the plurality of patch electrodes 108a and the plurality of patch electrodes 108b in this way, it is possible to make them symmetrical with respect to vertical and horizontal polarization.

As described above, in a reflecting device according to an embodiment of the present invention, the size of the patch electrodes of the reflector unit cell is at least two types. This allows two resonance frequency peaks (points where the reflectance is at a minimum) in the millimeter wave band to be obtained due to the resonance occurring in the patch electrode 108a and the resonance occurring in the patch electrode 108b. This makes it possible to suppress the attenuation of reflected waves and also to increase the amount of phase change. Due to these characteristics, even when multiple reflecting devices are combined to form a transmission path in the air, it is possible to suppress the attenuation of radio waves and ensure that communication devices can perform good communication.

The patch electrode 108 and the ground electrode 110 of the reflecting device according to an embodiment of the present invention can be formed using transparent conductive films. In addition, the liquid crystal layer 114 is also transparent. Therefore, the reflecting device can be attached to the windows of high-rise buildings and used to eliminate radio wave dead zones (places where radio waves do not reach) in urban areas by reflecting radio waves in a predetermined direction.

In this embodiment, although the case where the size of the patch electrode 108a is larger than the size of the patch electrode 108b has been described, this is not the only embodiment of the present invention. The size of the patch electrode 108a may be smaller than the size of the patch electrode 108b. In this case, the size of the patch electrode 108a is preferably 70% or more and 93% or less of the size of the patch electrode 108b. For example, the size of each patch electrode 108a is between 5.5 mm² or more and 7.0 mm² or less, and the size of each patch electrode 108b is between 7.0 mm² or more and 9.3 mm² or less.

### 2. Reflecting Device

Next, the structure of the reflecting device, which is made up of a number of radio wave reflecting units is explained.

### 2-1. Reflecting Device (Unidirectional Reflection Control)

FIG. 6 shows the configuration of a reflecting device 100a according to an embodiment of the present invention. The reflecting device 100a has a reflecting plate 120, a first drive circuit 124, and a terminal section 126.

A reflector 120 is provided between the dielectric substrate 104 and the counter substrate 106. The reflector 120 has a structure in which a plurality of reflector unit cells 102a and 102b are integrated. The plurality of reflector unit cells 102a and 102b are arranged in the first direction (the X-axis direction shown in FIG. 6) and the second direction (the Y-axis direction shown in FIG. 6) that intersects the first direction. The reflector unit cell 102a includes the ground electrode 110, the patch electrode 108a, and the liquid crystal layer (not shown) between the ground electrode 110 and the patch electrode 108a. The reflector unit cell 102b also includes the ground electrode 110, the patch electrode 108b, and the liquid crystal layer (not shown) between the ground electrode 110 and the patch electrode 108b. The patch electrodes 108a and 108b are provided on the dielectric substrate 104, and the ground electrode 110 is provided on the counter substrate 106. In addition, the dielectric substrate 104 and the counter substrate 106 are bonded together with the sealant 128, and the liquid crystal layer is provided in the region inside the sealant 128.

In the reflector unit cells 102a and 102b, the patch electrodes 108a and 108b are arranged so that they face the incident surface of the radio waves. The ground electrode 110 is flat. The plurality of patch electrodes 108a and 108b are arranged in a matrix within the plane of the flat ground electrode 110.

In this embodiment, when the reflector 120 is viewed in a plan view, the plurality of patch electrodes 108a and the plurality of patch electrodes 108b are arranged in a staggered pattern (Checked pattern). Specifically, the plurality of patch electrodes 108a and the plurality of patch electrodes 108b are arranged alternately in the first direction (the X-axis direction) or the second direction (the Y-axis direction) that intersects the first direction. In addition, each patch electrode 108a is adjacent to each patch electrode 108b in the first direction or the second direction.

The dielectric substrate 104 has a plurality of first wirings 118 extending in the second direction. Each of the plurality of first wirings 118 is electrically connected to the plurality of patch electrodes 108a and the plurality of patch electrodes 108b arranged in the second direction. In other words, the patch electrodes 108a and 108b arranged in the second direction are connected by the first wiring 118. The reflector 120 has a configuration in which a plurality of arrays of patch electrode arrays connected by the first wiring 118 is arranged in the second direction.

The region of the dielectric substrate 104 other than the region where the reflector 120 is provided is called a peripheral region 122. The peripheral region 122 has a first drive circuit 124 and a terminal section 126. The terminal section 126 is a region that forms a connection with an external circuit, and, for example, a flexible printed circuit is connected to the terminal section 126, which is not shown in the figure. A signal that controls the first drive circuit 124 is input to the terminal section 126 from the flexible printed circuit.

The plurality of first wirings 118 arranged on the reflector 120 extends to the peripheral region 122 and is connected to the first drive circuit 124. The first drive circuit 124 outputs control signals to the patch electrodes 108a and 108b via the first wiring 118. The first drive circuit 124 can output control signals with different voltage levels to each of the plurality of first wirings 118. As a result, the control signals are applied to the patch electrodes 108a and the patch electrodes 108b arranged in the first direction and the second direction, respectively, on the reflector 120.

A control signal is applied to each group of the plurality of patch electrodes 108 arranged in the second direction in the reflecting device 100a, and thereby the reflection direction of the reflected wave of the radio wave incident on the reflecting plate 120 can be controlled. In other words, the reflecting device 100a can control the direction of propagation of the reflected wave in the left-right direction of the drawing, with the reflected wave incident on the reflecting plate 120 centered on the reflecting axis RY parallel to the second direction (Y-axis direction).

In FIG. 6, the plurality of patch electrodes 108a and the patch electrodes 108b arranged in the second direction are electrically connected by the first wiring 118 to make them electrically equipotential. For this reason, it is also possible to replace them with a strip-shaped electrode that is continuous in the second direction (the Y-axis direction), rather than a shape that is divided into a plurality of parts. However, because there is an appropriate range of dimensions for the patch electrodes 108a and 108b depending on the wavelength of the reflected radio waves, if they are made into a strip-shaped electrode, the sensitivity to the target wavelength will decrease, and the behavior with respect to vertical and horizontal polarization will differ. Therefore, as shown in FIG. 6, the patch electrodes 108a and 108b are arranged in an array in a shape that is symmetrical with respect to vertical and horizontal polarizations (in FIG. 6, a square is shown, but it may also be circular). It is preferable to have a structure in which the plurality of patch electrodes 108a and 108b arranged parallel to the reflection axis RY are connected by the first wiring 118.

### 2-2. Reflecting Device (Two-Axis Reflecting Control)

The reflecting device 100a shown in the first embodiment has a single reflecting axis (RY), so the reflecting angle can be controlled in the direction of the reflecting axis (RY). In contrast, this embodiment shows an example of a reflecting device 100b that can perform two-axis reflecting control. The following explanation focuses on the parts that differ from the second embodiment.

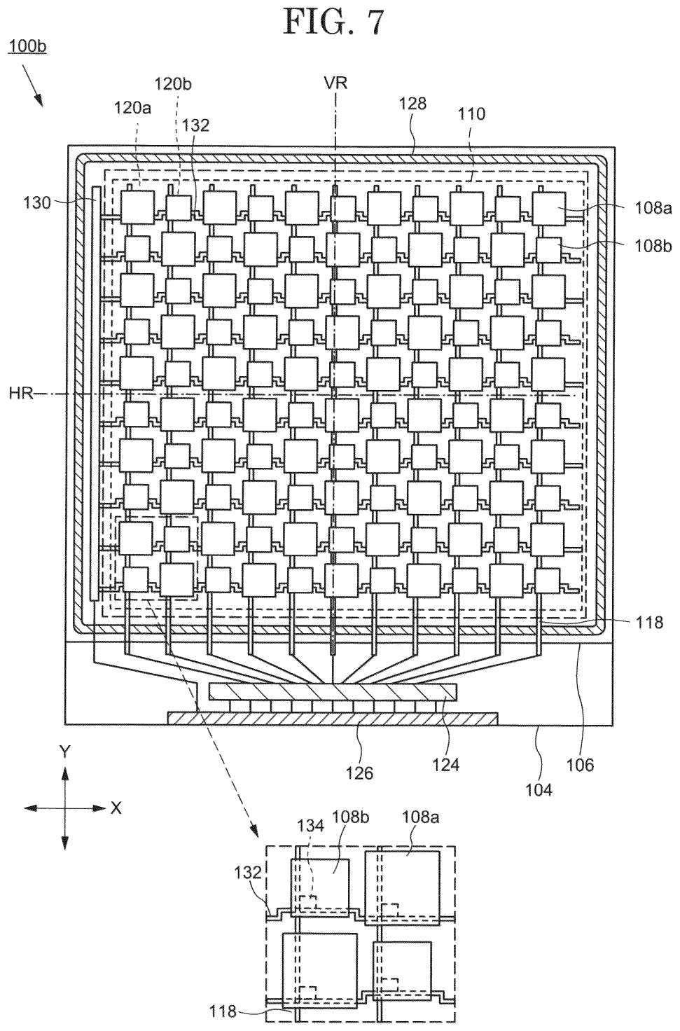

FIG. 7 shows the configuration of the reflecting device 100b of this embodiment. The following explanation focuses on the parts that differ from the reflecting device 100a shown in FIG. 6.

The reflecting device 100b has the plurality of first wirings 118 extending in the second direction (Y-axis direction) on the reflector 120, as well as a plurality of second wirings 132 extending in the first direction (X-axis direction). The plurality of first wirings 118 and the plurality of second wirings 132 are arranged to intersect each other across an insulating layer not shown in the figure. The plurality of first wirings 118 is connected to the first drive circuit 124, and the plurality of second wirings 132 is connected to the second drive circuit 130. The first drive circuit 124 outputs a control signal, and the second drive circuit 130 outputs a scanning signal.

FIG. 7 shows an enlarged insert diagram of the arrangement of the two patch electrodes 108a and the two patch electrodes 108b, and the two first wirings 118 and the second wiring 132. A switching element 134 is provided in each of the two patch electrodes 108a and the two patch electrodes 108b. The switching (on and off) of the switching element 134 is controlled by the scanning signal applied to the second wiring 132. When the switching element 134 is turned on, the patch electrode 108 is connected to the first wiring 118 and a control signal is applied. The switching element 134 is formed, for example, by a thin film transistor. With this configuration, it is possible to select the plurality of patch electrodes 108a and 108b arranged in the first direction (X-axis direction) in groups and apply control signals with different voltage levels to each group.

As shown in FIG. 7, the reflecting device 100b can control the direction of reflected waves in the left-right direction of the drawing, with a reflecting axis VR parallel to the second direction (Y-axis direction), and can also control the direction of reflected waves in the up-down direction of the drawing, with the reflecting axis HR parallel to the first direction (X-axis direction). In other words, the reflecting device 100b has the reflection axis VR parallel to the second direction (Y-axis direction) and a reflection axis HR parallel to the first direction (X-axis direction), so it is possible to control the reflection angle in the direction of the reflection axis VR as the rotation axis and in the direction of the reflection axis HR as the rotation axis.

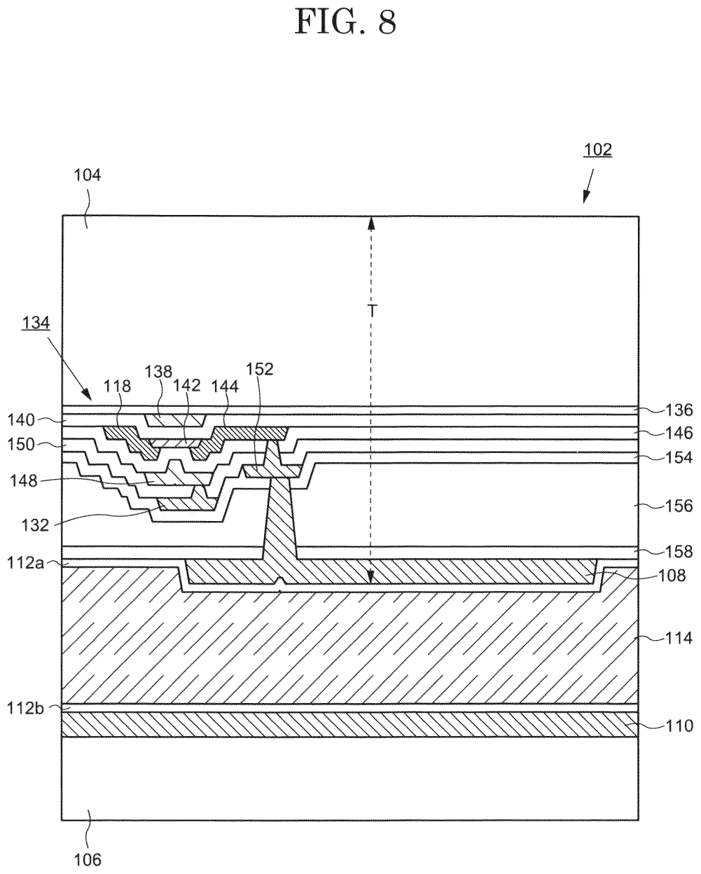

FIG. 8 shows an example of the cross-sectional structure of the reflector unit cell 102 in which the switching element 134 is connected to the patch electrode 108. The switching element 134 is provided on the dielectric substrate 104. The switching element 134 is a transistor, and has a layered structure comprising a first gate electrode 138, a second gate insulating layer 146, a semiconductor layer 142, and a second gate electrode 148. An undercoat layer 136 may be provided between the first gate electrode 138 and the dielectric substrate 104. The first wiring 118 is provided between a first gate insulating layer 140 and the second gate insulating layer 146. The first wiring 118 is provided in contact with a semiconductor layer 142. In addition, a first connecting wiring 144 is provided in the same layer as the conductive layer forming the first wiring 118. The first connecting wiring 144 is provided in contact with the semiconductor layer 142. The connection structure of the first wiring 118 and the first connecting wiring 144 to the semiconductor layer 142 shows a structure in which one of the wires is connected to the source of the transistor and the other is connected to the drain.

A first interlayer insulating layer 150 is provided to cover the switching element 134. The second wiring 132 is provided on the first interlayer insulating layer 150. The second wiring 132 is connected to the second gate electrode 148 via a contact hole formed in the first interlayer insulating layer 150. Although not shown in the figure, the first gate electrode 138 and the second gate electrode 148 are electrically connected to each other in a region that does not overlap the semiconductor layer 142. On the first interlayer insulating layer 150, a second connecting wiring 152 is provided with the same conductive layer as the second wiring 132. The second connecting wiring 152 is connected to the first connecting wiring 144 via a contact hole formed in the first interlayer insulating layer 150.

A second interlayer insulating layer 154 is provided to cover the second wiring 132 and the second connecting wiring 152. In addition, a planarization layer 156 is provided to fill in the gaps in the switching element 134. By providing the planarization layer 156, the patch electrode 108 can be formed without being affected by the arrangement of the switching element 134. A passivation layer 158 is provided on the flat surface of the planarization layer 156. The patch electrode 108 is formed on the passivation layer 158. The patch electrode 108 is connected to the second connecting wiring 152 via a contact hole that penetrates the passivation layer 158, the flattening layer 156, and the second interlayer insulating layer 154. The first orientation film 112a is formed on the patch electrode 108.

The counter substrate 106 is provided with the ground electrode 110 and the second alignment film 112b, as shown in FIG. 1B. The surface of the dielectric substrate 104 on which the switching element 134 and the patch electrode 108 are provided is arranged to face the surface of the counter substrate provided with the ground electrode 110, and the liquid crystal layer 114 is provided between them. The thickness T of the dielectric substrate 104 can be defined as the length from the surface of the patch electrode 108 on the liquid crystal layer 114 side to the surface of the dielectric substrate 104 opposite the surface on which the patch electrode 108 is provided. In this case, the thickness of at least one insulating layer (the undercoat layer 136, the first gate insulating layer 140, the second gate insulating layer 146, the first interlayer insulating layer 150, the second interlayer insulating layer 154, the planarization layer 156, and the passivation layer 158) can be taken into account.

Each layer formed on the dielectric substrate 104 is formed using the following materials. The undercoat layer 136 is formed using a silicon oxide film, for example. The first gate insulating layer 140 and the second gate insulating layer 146 are formed using a silicon oxide film or a layered structure of a silicon oxide film and a silicon nitride film, for example. The semiconductor layer is formed of an oxide semiconductor layer, including silicon semiconductors such as amorphous silicon and polycrystalline silicon, and metal oxides such as indium oxide, zinc oxide, gallium oxide, and IGZO. The first gate electrode 138 and the second gate electrode 148 may be composed of molybdenum (Mo), tungsten (W), or an alloy thereof. The first wiring 118, the second wiring 132, the first connecting wiring 144, and the second connecting wiring 152 are formed using metal materials such as titanium (Ti), aluminum (Al), and molybdenum (Mo). For example, it may be composed of a layered structure of titanium (Ti)/aluminum (Al)/titanium (Ti) or a layered structure of molybdenum (Mo)/aluminum (Al)/molybdenum (Mo). The planarization layer 156 is formed from a resin material such as acrylic or polyimide. The passivation layer 158 is formed from a silicon nitride film, for example. The patch electrode 108 and the ground electrode 110 are formed from a metal film such as aluminum (Al) or copper (Cu), or a transparent conductive film such as indium tin oxide (ITO).

As shown in FIG. 8, since the second wiring 132 is connected to the gate of a transistor that uses the switching element 134, and the first wiring 118 is connected to one of the source and drain of the transistor and connects the patch electrodes 108 to the other side of the source and drain, it is possible to select a specified patch electrode from among the plurality of patch electrodes 108 arranged in a matrix pattern and apply a control signal. By providing the switching element 134 in each of the individual patch electrodes 108 in the reflector 120, it is possible to apply a control voltage to each of the patch electrodes 108 arranged in a single horizontal row along the first direction (X-axis direction) or each of the patch electrodes 108 arranged in a single vertical row along the second direction (Y-axis direction) can be controlled. For example, when the reflector 120 is upright, the direction of reflection of the reflected wave can be controlled in the left-right and up-down directions.

### First Modification

In the first and second embodiments, although an example was described in which one patch electrode 108a and one patch electrode 108b are arranged alternately in the first and second directions, this is not limited to one embodiment of the present invention. For example, three patch electrodes 108a and three patch electrodes 108b may be arranged alternately in the first and second directions.

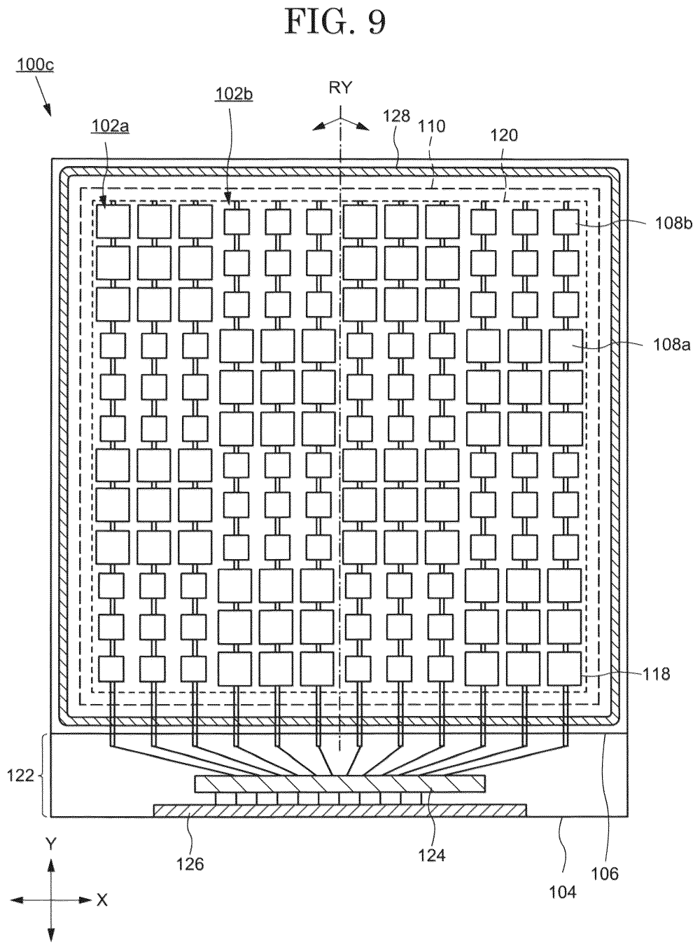

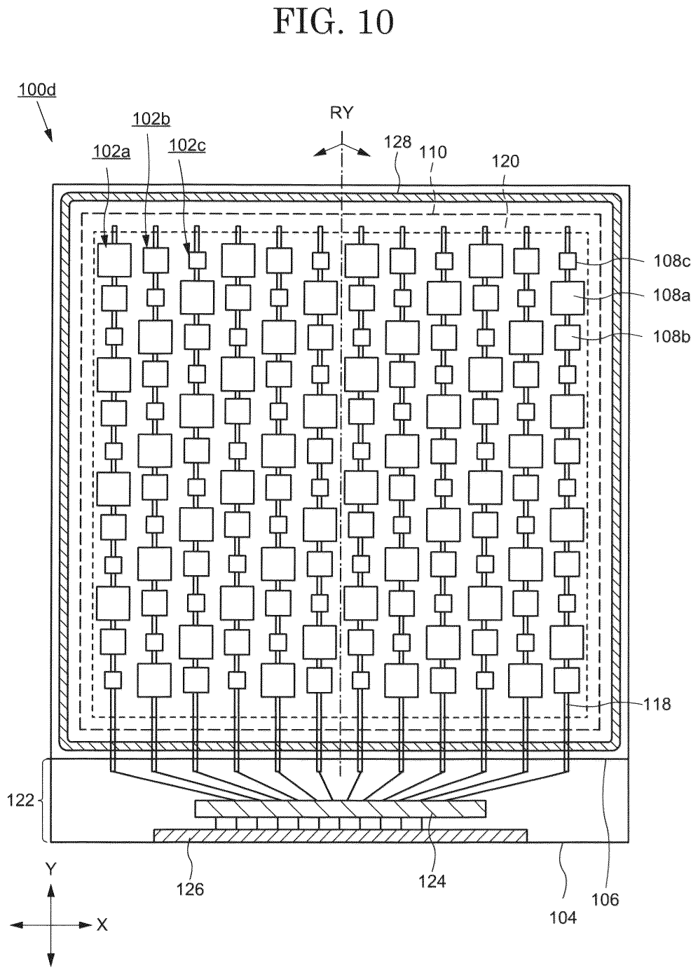

FIG. 9 shows the configuration of the reflecting device 100c according to the first modification. As shown in FIG. 9, in the reflecting device 100c, the three patch electrodes 108a and the three patch electrodes 108b are arranged alternately in the first and second directions. By arranging the plurality of patch electrodes 108a and the plurality of patch electrodes 108b in this way, it is possible to make them symmetrical with respect to vertical and horizontal polarization.

Furthermore, the number of patch electrodes 108a and patch electrodes 108b arranged in a row is not limited to three. The number of patch electrodes 108a and patch electrodes 108b arranged in a row may be two, or may be four or more. The number of patch electrodes 108a and patch electrodes 108b arranged in a row is not particularly limited. However, it is preferable that the plurality of patch electrodes 108a and the plurality of patch electrodes 108b are arranged so that the plurality of patch electrodes 108a and the plurality of patch electrodes 108b are rotationally symmetric twice or rotationally symmetric four times with respect to the center of the region where the plurality of patch electrodes 108a and the plurality of patch electrodes 108b are arranged in the first direction and the second direction. By arranging the plurality of patch electrodes 108a and the plurality of patch electrodes 108b in this way, it is possible to make them symmetrical with respect to vertical and horizontal polarization.

### Second Modification

In the first and second embodiments, although reflecting devices 100a, 100b, and 100c that use two types of patch electrodes 108a and 108b of different sizes were described, this is not limited to one embodiment of the present invention. In the reflecting devices 100a, 100b, and 100c, patch electrodes of a size different from that of the patch electrodes 108a and 108b may be used.

FIG. 10 shows the configuration of the reflecting device 100d according to the second modification. As shown in FIG. 10, the size of the patch electrode 108c may be smaller than the sizes of the patch electrodes 108a and 108b. Alternatively, the size of the patch electrode 108c may be larger than the sizes of the patch electrodes 108a and 108b. Alternatively, the size of the patch electrode 108c may be between the sizes of the patch electrodes 108a and 108b. In this way, by having three or more types of patch electrode size, the amount of phase change can be increased. However, it is preferable that the plurality of patch electrodes 108a, the plurality of patch electrodes 108b, and a plurality of patch electrodes 108c are arranged so that they are two-fold rotationally symmetric or four-fold rotationally symmetric with respect to the center of the region where the plurality of patch electrodes 108a, the plurality of patch electrodes 108b, and the plurality of patch electrodes 108c are arranged in the first direction and the second direction. By arranging the plurality of patch electrodes 108a, the plurality of patch electrodes 108b, and the plurality of patch electrodes 108c in this way, it is possible to make them symmetrical with respect to vertical and horizontal polarization.

In the reflecting devices 100a, 100b, 100c, and 100d according to an embodiment of the present invention, a phase change of 360° is sufficient. Therefore, the size of the patch electrode 108c may be determined as appropriate to ensure that 360° is secured. In this case, the size of the patch electrode 108c is 6.5 mm² or more and 8.5 mm² or less.

In addition, although the reflecting device with single-axis reflection control was described in the first and second modifications, the first and second modifications may also be applied to a reflecting device with dual-axis reflection control.

The various configurations of the reflecting device and reflector unit shown as examples of an embodiment of the present invention can be combined as appropriate as long as they do not contradict each other. In addition, the reflecting device and reflector unit disclosed in this document and the drawings can be used as the basis for the addition, deletion or design change of configuration elements, or the addition, omission or change of conditions, as appropriate, by a person skilled in the art, and as long as they have the gist of the present invention, they are also included in the scope of the present invention.

Even if the effects are different from the effects of the embodiments disclosed in this document, if they are clear from the description in this document or can be easily predicted by a person skilled in the art, they are naturally considered to be brought about by the present invention.

What is claimed is:

1. A reflecting device comprising:
a plurality of first patch electrodes;
a plurality of second patch electrodes having a size different from a size of the first patch electrodes;
a ground electrode opposing the plurality of first patch electrodes and the plurality of second patch electrodes and separated from the plurality of first patch electrodes and the plurality of second patch electrodes; and
a liquid crystal layer between the plurality of first patch electrodes and the plurality of second patch electrodes and the ground electrode,
wherein
the plurality of first patch electrodes and the plurality of second patch electrodes are arranged alternately in a first direction or a second direction intersecting the first direction, and
each first patch electrode is adjacent to each second patch electrode in the first direction or the second direction.

2. The reflecting device according to claim 1, wherein
a shape of each first patch electrode and a shape of each second patch electrode are rotationally symmetric.

3. The reflecting device according to claim 1, wherein
a shape of each first patch electrode and a shape of each second patch electrode are square, diamond, square with chamfered corners, square with rounded corners, or circular.

4. The reflecting device according to claim 1, wherein
a size of each first patch electrode is 107% or more and 140% or less of a size of each second patch electrode.

5. The reflecting device according to claim 1, wherein
a size of each first patch electrode is 7.0 mm² or more and 9.3 mm² or less, and a size of each second patch electrode is 5.5 mm² or more and 7.0 mm² or less.

6. The reflecting device according to claim 1, wherein
a size of each first patch electrode is 70% or more and 93% or less of a size of each second patch electrode.

7. The reflecting device according to claim 1, wherein
a size of each first patch electrode is 5.5 mm² or more and 7.0 mm² or less, and a size of each second patch electrode is 7.0 mm² or more and 9.3 mm² or less.

8. The reflecting device according to claim 1, wherein
the plurality of first patch electrodes and the plurality of second patch electrodes are arranged so that an entire region of the plurality of first patch electrodes and the plurality of second patch electrodes is rotationally symmetric about a center of a region where the plurality of first patch electrodes and the plurality of second patch electrodes are arranged in the first direction and the second direction.

9. The reflecting device according to claim 1, wherein
a frequency of radio waves incident on the plurality of first patch electrodes and the plurality of second patch electrodes is 28 GHz or a frequency close to 28 GHz.

10. The reflecting device according to claim 1, wherein
each of the plurality of first patch electrodes and the plurality of second patch electrodes is connected to each of a plurality of switching elements.
